(19) United States
(12) Patent Application Publication
(10) Pub. No.: US 2017/0351291 A1
(43) Pub. Date: Dec. 7, 2017

(54) CLUTCH PEDAL WITH FORCE SIMULATION

(71) Applicant: Ford Global Technologies, LLC, Dearborn, MI (US)

(72) Inventors: Steffen SCHOENFUSS, Odenthal NRW (DE); Christina KALLAS, Rommerskirchen NRW (DE)

(73) Assignee: Ford Global Technologies, LLC, Dearborn, MI (US)

(21) Appl. No.: 15/611,345

(22) Filed: Jun. 1, 2017

(30) Foreign Application Priority Data
Jun. 3, 2016 (DE) 102016209827.6

(51) Int. Cl. G05G 5/03; G05G 1/44; B60K 23/02; B60T 7/06; B60K 26/02

(52) U.S. Cl. CPC G05G 5/03; G05G 1/44; B60K 23/02; B60K 26/021; B60T 7/06

(57) ABSTRACT

A clutch pedal for an electrically operated clutch system simulates the pedal forces of a hydraulically actuated clutch. An operating element is pivotably supported on a mounting so as to move along an operating path between a non-operating position and an operating position. A restoring spring applies a force towards the non-operating position. At least one friction element rubs against a curved friction surface when the operating element is pivoting along the operating path. The friction element is spring-loaded against the friction surface. During operation between the operating position and the non-operating position, the friction element moves over a cam lobe of the friction surface. The friction element is elastically movable radially in relation to the curved friction surface.

### CROSS-REFERENCE TO RELATED APPLICATIONS

This application claims foreign priority benefits under 35 U.S.C. §119(a)-(d) to DE Application 10 2016 209 827.6 filed Jun. 3, 2016, which is hereby incorporated by reference in its entirety.

### TECHNICAL FIELD

The present invention concerns an apparatus for force simulation on an operating element of a vehicle, such as a pedal or an electrically operated clutch system.

### BACKGROUND

In the drive train of a motor vehicle, for example of an automobile or similar, as well as with motor cycles, there is a friction clutch that is used both as a starting element and as a shift element. Hydraulically operated clutches have predominated for operating the clutch by the driver of the vehicle in the past.

With such a clutch operating system, an operating element is provided in the form of the clutch pedal to be operated by the driver for example or, in the case of a motor cycle, a clutch lever is provided, wherein the driver of the vehicle operates the clutch pedal with the foot to disengage the clutch or in the case of a motor cycle pulls the clutch lever towards the handlebar by hand. By doing this, a hydraulic fluid is displaced by the clutch release cylinder, whereby a hydraulic pressure is produced, which in turn is used by the clutch slave cylinder to disengage the clutch.

From the prior art it is already known to implement the vehicle driver's demand electronically, for example so-called “brake-by-wire”, “drive-by-wire” or “clutch-by-wire”, i.e. the electronic implementation of a driver's braking demand, of a load demand predetermined by the driver with a gas operating element or of a clutch demand, without there being a mechanical connection between a brake operating element (for example a brake pedal), a gas operating element (for example a gas pedal) or a clutch operating element (for example a clutch pedal) and the associated final control element thereof, i.e. a vehicle brake system, a load control element of a vehicle drive unit or a vehicle clutch. For this purpose, the driver's demand is only detected by means of a position sensor on the corresponding operating element, then forwarded electronically, for example by an electronic control device, and finally implemented by a suitable actuator that is supplied with auxiliary energy. Because the operating element only provides an electrical signal in this case, suitable measures are to be provided on the operating element, for example the brake pedal, the gas pedal and/or the clutch pedal, using which a customary operating feel is produced for the driver during the operation of the operating element.

Thus, for example, an electronically controllable gas pedal of a vehicle with a kickdown function is known from US 2007/0234842 A1, which gives a driver haptic feedback by means of a predetermined force-travel characteristic. For this purpose, the gas pedal is pivotably supported on the vehicle, wherein a friction element is connected to the gas pedal that rubs against a curved first friction surface during pivoting of the gas pedal. Furthermore, a second friction surface contacts the first friction surface by means of a friction surface step, which requires a greater force application on the gas pedal to overcome, whereby the driver is given haptic feedback during activation of the kickdown function.

In DE 101 05 265 A1, a restoring apparatus for pedals of a motor vehicle is described, with which the pedal is pivotably fixed to a vehicle body by means of a spring element. Furthermore, a friction element that rubs along a friction surface provided on the body when the pedal is operated is connected to the pedal.

A clutch pedal device is known from DE 10 2012 217 541 A1 with a rotatably supported clutch pedal and means for producing a predetermined profile of pedal force against pedal travel. The profile of the pedal force against pedal travel has a segment with a negative gradient following a segment with a positive gradient. The means for producing the predetermined force-travel profile provides that the pedal arm acts on a rotatably supported lever arm that is subjected to a counter force and is displaced on a contour of the lever arm during operation of the clutch pedal.

DE 10 2011 075 603 A1 describes a gas pedal unit for motor vehicles, wherein a change in position of the pedal plate relative to the initial position thereof against a restoring force of a restoring spring that is caused by a corresponding operating force results in an increase in the drive force of an engine, and with decreasing operating force the restoring force of the restoring spring returns the pedal plate towards the initial position thereof. Means are further provided that produce a hysteresis in the pedal characteristic, wherein the means are in the form of a friction element and a friction surface that interacts with the friction element. The friction element is spring-loaded against the friction surface. The friction surface is connected to the pedal plate and is rotated relative to the friction element during operation of the pedal plate.

WO2015/165451 A1 discloses an apparatus for force simulation on an operating element of a vehicle with a piston-cylinder unit. A working piston is connected to the operating element by means of a piston rod that moves the piston axially within the cylinder. A resistance element along which the piston is displaced frictionally depending on the position of the operating element protrudes into the cylinder at right angles to the direction of motion of the piston.

From EP 2 896 539 A2, a system for pedal force simulation for a clutch operating system is known, with which the pedal can be operated with a pedal force and interacts with a piston that is axially displaceable in a housing against a restoring force of a restoring spring. The position of the pedal is detected by means of a sensor and is passed to an actuator arrangement acting on the clutch. The piston interacts with at least one further elastic element that provides a hysteresis with a rising and falling force profile.

Furthermore, DE 11 2012 001 380 T5 describes an electronic clutch arrangement that provides a realistic pedal feel, wherein the resistance on the clutch pedal rises until the point of release of the clutch and the resistance on the clutch pedal decreases after the point of release of the clutch. For this purpose, a clamping device that is both rotatable and compressible is provided between a clutch pedal arm and a pedal arm mounting.

Furthermore, an upright clutch pedal for a motor vehicle is known from DE 10 2007 018 962 A1 that comprises a position sensor, based on the signals of which a clutch that is provided in the vehicle's drive train is electronically controlled and is operated accordingly by means of an actuator that is supplied with auxiliary energy. Spring elements engaging the clutch pedal are provided for producing a pedal force characteristic that reproduces the pedal force that is detectable by the driver against pedal travel, so that the pedal force characteristic exhibits an initially steadily rising profile of the operating force starting from the neutral position of the clutch pedal until a maximum force and then transitions into a decreasing profile thereafter, wherein for producing said pedal force characteristic an over center spring is provided in addition to a coil spring that moves the clutch pedal into the neutral position thereof. Furthermore, a speed-dependent damper is fitted between the clutch pedal and the pedal block.

A damper unit that can be fitted retrospectively to a pedal device for imparting a more natural pedal operating feel is disclosed in US 2014/0217658 A1. The damper unit is fitted beneath the pedal arm and is set in rotation by operating the pedal arm, whereby in turn a torque acting on the pedal arm is produced.

EP 1 645 769 A2 describes an apparatus for operating a clutch by means of an operating lever, wherein the operating lever acts on a clutch release cylinder, by means of which the release force acting on a clutch slave cylinder for disengaging the clutch can be controlled. A gearbox is disposed between the operating lever and the clutch release cylinder for producing a transmission ratio of the force transfer path that can be varied against the operating travel of the operating lever.

### SUMMARY

Against this background, it is the object of the present invention to provide an apparatus for force simulation on an operating element of a vehicle that imparts the same feel to the user that is operating the operating element, for example a driver of the vehicle, as if the operating element were being used for operating a hydraulic system that is mechanically connected thereto, for example. Moreover, the apparatus should be simple to manufacture and of a compact construction. Furthermore, an electrically operated clutch system of a vehicle with the same advantageous properties will be demonstrated.

It is to be noted that the features that are mentioned individually in the following description can be combined with each other in any technically meaningful manner and reveal further embodiments.

An apparatus for force simulation on an operating element of a vehicle that imparts haptic feedback by means of a predetermined force-travel characteristic comprises a mounting for pivotably attaching the operating element to the vehicle. The operating element, for example an operating lever or a pedal, is supported to be pivotable about a pivot axis on the mounting along an operating path between a non-operating position and an operating position. Furthermore, a restoring force of a restoring spring acts on the operating element towards the non-operating position thereof. Furthermore, at least one friction element rubs against a curved friction surface when the operating element is pivoting along the operating path. The friction element is spring-loaded against the friction surface. The friction surface comprises at least one cam, wherein during the operation of the operating element along the operating path, the friction surface and the friction element are displaced relative to each other in such a way that the friction element moves along the curved friction surface at least towards or over the cam.

A cam means in this case is an essentially rounded protrusion on the otherwise flat and curved friction surface. Such a cam preferably comprises a rising edge in relation to the friction surface, a maximum and a falling edge, so that an increase in the or on the friction surface results from the cam.

Because the friction element rubs along the friction surface during the operation of the operating element along the operating path between the non-operating position and the operating position, is spring-loaded against the cam, and moves at least on the cam and preferably over the cam, a friction force profile results that is dependent on the operating angle of the operating element. In combination with the restoring force of the restoring spring that varies linearly with the operating angle of the operating element, a reaction force acts on the operating element that essentially corresponds to the reaction force that an operator of the operating element would experience if the operating element were to be mechanically coupled to a conventional, for example hydraulic, system for the operation thereof.

Because the friction surface is also curved, the apparatus can be constructed more compactly than would be the case for a linear friction surface. The at least one friction element is moved on a circular path, wherein the friction surface is at rest relative to the mounting, or the curved friction surface can rotate past the friction element, wherein in this case the friction element could be at rest on the mounting in the direction of motion of the friction surface.

The at least one friction element is mounted on the mounting to be radially movable elastically in relation to the curved friction surface, and the friction surface is joined to an axle bolt that supports the operating element on the mounting, that is rotatable about the pivot axis and that is rotationally fixedly joined to the operating element. Accordingly, the friction surface rotates about the pivot axis during the operation of the operating element along the operating path. This provides an apparatus that is compactly constructed and simple to manufacture, because the at least one friction element is supported on the mounting to be movable only radially relative to the curved friction surface and biased against the friction surface by a spring element, whereas the friction surface is rotated about the pivot axis on the friction element due to operation of the operating element.

An advantageous embodiment provides that a respective friction surface and at least one friction element are disposed on each axial end of the axle bolt in each case. This enables in a simple and compact manner the frictional force acting on the friction surface during the operation of the operating element to be doubled or the contact force to be reduced for the same total driving force between each spring-loaded friction element and the respective friction surface, in order thereby to keep the wear on the friction elements as low as possible and thereby to increase the service life and durability of the apparatus.

As has already been explained above, the friction surface is curved. In a particularly advantageous embodiment, the friction surface can be curved according to an arc of a circle. It can however for example also be curved elliptically, parabolically, hyperbolically and similarly.

According to an advantageous embodiment, the friction surface is formed by an external peripheral surface of a cam disk forming at least one sector of a circle or by an internal peripheral surface of a cam ring forming at least one arc of a circle. In the first case, the at least one friction element is spring-biased radially from the outside against the external peripheral surface of the cam disk. In the second case, the at least one friction element is spring-biased radially from the inside against the internal peripheral surface of the cam ring. In both cases, both the cam disk and the cam ring can be supported rotatably on the mounting of the operating element and can be set in rotation as a result of the operation of the operating element, so that they rotate past the at least one corresponding friction element, or the at least one respective friction element can be supported on the mounting of the operating element so as to be rotatable about the cam disk or within the cam ring and can move along the friction surface that is provided by the cam disk or the cam ring as a result of the operation of the operating element.

According to yet another advantageous embodiment, at least two friction elements are provided and the friction surface is in the form of a fully peripheral cylindrical shell surface, on which at least two diametrically disposed cams are disposed. In this case, the friction elements are also diametrically disposed and each is associated with a cam in such a way that the friction surface and each friction element move relative to each other in such a way during the operation of the operating element along the operating path that a respective friction element is moved along the friction surface at least towards or over the cam that is associated therewith. This enables in a simple and compact manner the frictional force acting on the operating element during the operation of the operating element to be increased or the contact force to be reduced for the same total driving force between each spring-loaded friction element and the friction surface, in order thereby to keep the wear on the friction elements as low as possible and thereby to increase the service life and the durability of the apparatus.

A further advantageous embodiment provides that the side of the friction element facing the friction surface comprises a contour that is concave in relation to the friction surface. This enables the side of the at least one friction element facing the friction surface to essentially adapt to the shape of the cam of the friction surface, so that a more controllable force profile of the friction between the friction element and the friction surface results when the friction element is moving towards or over the cam.

Likewise, during the operation of the operating element, the force profile of the friction between the at least one friction element and the friction surface, in particular during the movement of the friction element towards or over the cam of the friction surface, can be improved according to yet another advantageous embodiment by providing a respective chamfer on the side of the friction element facing the friction surface on the front side and/or rear side of the friction element defined in relation to the direction of motion of the friction element. The chamfer or inclination of the friction element on the front side and/or rear side thereof enables adaptation of the friction surface to the gradient of the rising or falling edge of the cam and thereby better control of the frictional force produced on the friction element.

According to a further advantageous embodiment, at least one plate spring is provided per friction element that biases the friction element relative to the friction surface radially against said friction surface.

According to a further advantageous embodiment, the restoring spring can be a linearly operated spring element, for example a helical spring. Said spring can for example be disposed in the case of a clutch pedal as the operating element instead of the clutch release cylinder of a conventional hydraulic clutch operating device, so that overall a more compact structure of the apparatus results.

The apparatus is preferably for force simulation on the operating element of a pedal force simulator of a motor vehicle.

According to a further aspect, an electrically operated clutch system for vehicles is provided that comprises an operating element, for example a clutch pedal or a clutch lever, which is provided with an apparatus for force simulation on the operating element. In this case, the operating position of the operating element is detected by a sensor unit and is electrically forwarded to a control unit that works in conjunction with a clutch of the vehicle to operate said clutch by means of a suitable actuator arrangement. The apparatus for force simulation is designed according to one of the embodiments that are described above in this case. Further embodiments of the electrically operated clutch system, the effects and advantages of which result directly from the above description of the apparatus for force simulation on the operating element and can also usefully be used on the electrically operated clutch system according to the invention.

Further features and advantages of the invention result from the following description of an exemplary embodiment, which is to be understood as non-limiting, which is described in detail below with reference to the drawings. The following are shown schematically in the drawings:

### BRIEF DESCRIPTION OF THE DRAWINGS

FIG. 1 is a perspective side view from the right of an apparatus for force simulation on an operating element of a vehicle.

FIG. 2 is a perspective side view of the apparatus of FIG. 1 from the left.

FIG. 3 is an enlarged, lateral sectional view of the apparatus of FIG. 1 in the region of the pivot axis.

FIG. 4 is a set of force-travel graphs to describe the operation of the apparatus of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the different figures, equivalent parts regarding the function thereof are provided with the same reference characters.

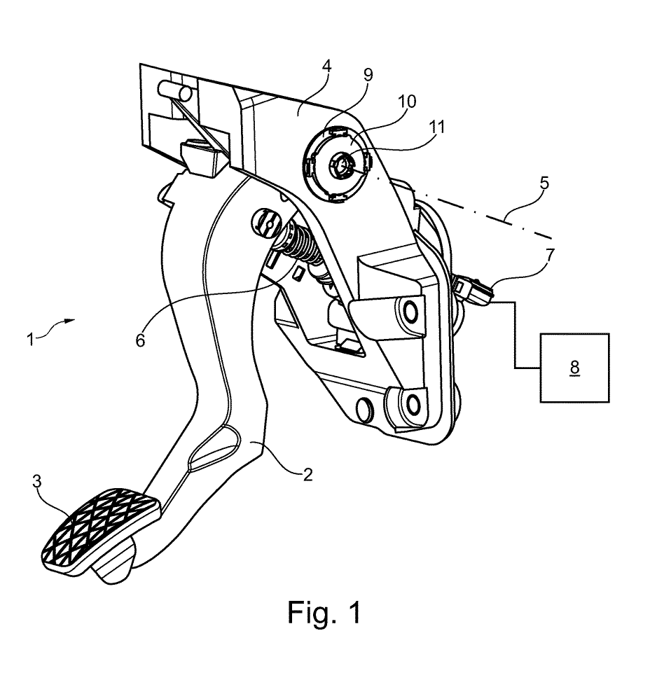

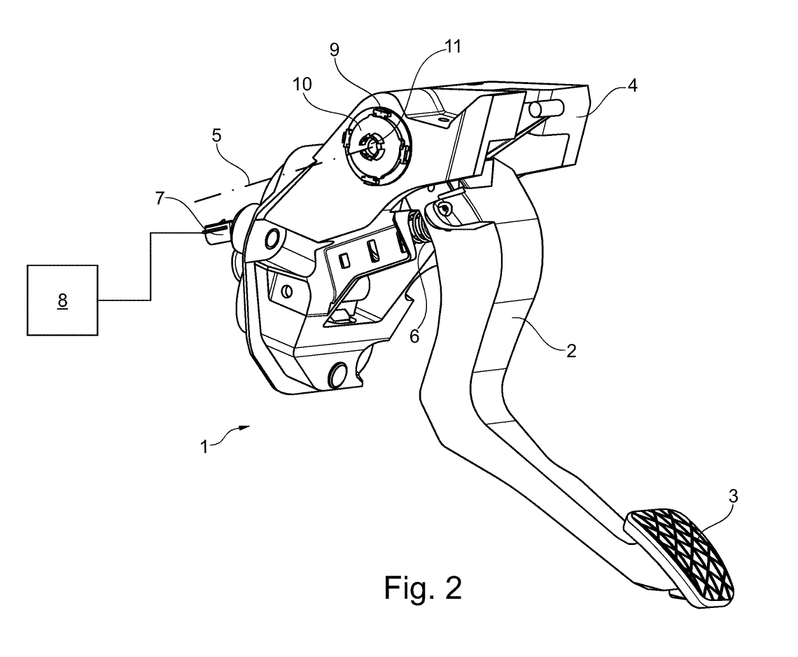

FIG. 1 shows a perspective side view from the right of an apparatus 1 for force simulation on an operating element 2 of a vehicle (not shown), and FIG. 2 shows a perspective side view of the apparatus 1 from the left. As can be seen from FIG. 1, the operating element 2 of the represented exemplary embodiment is a pedal arm 2 that comprises a pedal plate 3 on a free end for operating the pedal arm 2 by a driver of the vehicle with his foot (not shown). With the exemplary embodiment of the apparatus 1 shown in FIG. 1, the operating element 2 is a clutch pedal for the electrical operation of a clutch system of the vehicle.

The operating element 2 is pivotably connected to a mounting 4 at the end of the pedal arm 2 opposite the free end thereof. The mounting 4 is used to attach the operating element 2 to the vehicle by being able for its part to be fixed to a part of the body of the vehicle, for example.

The operating element 2 or the pedal arm 2 is supported on the mounting 4 to pivot about a pivot axis 5 along an operating path between a non-operating position, in which the operating element 2 does not operate and is in the neutral position thereof, and an operating position, in which the operating element 2 is depressed.

Furthermore, a restoring force of a restoring spring 6 acts on the operating element 2 towards the non-operating position. Advantageously, in the exemplary embodiment of the apparatus 1 shown, the restoring spring 6 is a linearly operated restoring spring 6, such as for example a coil spring that extends essentially axially and in a straight line (for example a helical spring). Said spring is disposed in the apparatus 1 shown in FIG. 1 in the same position in which the clutch release cylinder would be disposed in a conventional hydraulic clutch system. Thereby the installation space for the clutch release cylinder that is no longer required in an electrically operated clutch system can be advantageously used for disposing the restoring spring 6, which enables a compact structure of the apparatus 1.

As already mentioned above, the operating element 2 of the exemplary embodiment of the apparatus 1 represented in FIG. 1 is a clutch pedal for the electrical operation of a clutch system of the vehicle. For this purpose, the operating position of the operating element 2 is detected by a sensor unit 7 and is electrically forwarded to a control unit 8 that works in conjunction with a clutch of the vehicle (not shown) to operate said clutch by means of a suitable actuator arrangement (likewise not shown) according to the operating position of the operating element 2.

As can be seen from FIGS. 1 and 2, four friction elements 9 in each case are disposed evenly distributed concentrically and circumferentially, i.e. diametrically, about the pivot axis 5 both on the right side and on the left side of the pivot bearing of the operating element 2 on the mounting 4. The friction elements 9 are spring-loaded against a curved friction surface 10. When the operating element 2 is pivoted about the pivot axis 5, the friction elements 9 rub on the friction surface 10 due to relative movement between the friction elements 9 and the friction surface 10.

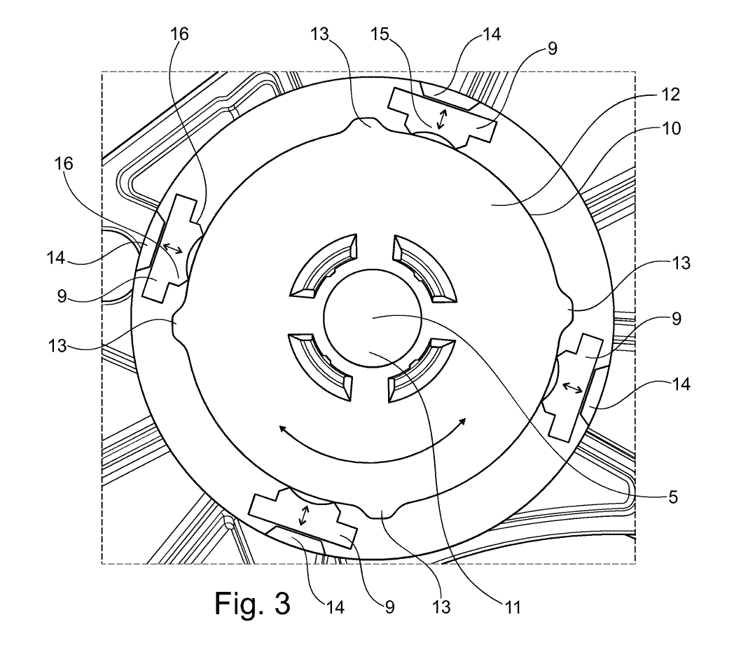

The arrangement and configuration of the friction elements 9 and the friction surface 10 are detailed in the lateral sectional view shown in FIG. 3 in the region of the pivot axis 5. It can be seen in FIG. 3 that an axle bolt 11 that is rotatable about the pivot axis 5 is supported on the mounting 4 concentric to the pivot axis 5. The operating element 2 is rotationally fixedly joined to the axle bolt 11, so that the axle bolt 11 turns about the pivot axis 5 in the mounting 4 during the operation of the operating element 2. Furthermore, the friction surface 10 is rotationally fixedly joined to the axle bolt 11, so that the friction surface 10 also turns about the pivot axis 5 with the axle bolt 11 during the operation of the operating element 2.

With the exemplary embodiment of the apparatus 1 shown in FIG. 3, it can further be seen that the friction surface 10 is formed by an external peripheral surface of a cam disk 12 forming a complete circle in the side view shown. The friction surface 10 thereby extends in said version along an arc of a circle, because the friction surface 10 is formed by a complete peripheral cylindrical shell surface of the cam disk 12. The cam disk 12 comprises a total of four cams 13 on the external peripheral surface thereof, i.e. the friction surface 10. The cams 13 are disposed in an even distribution similarly to the friction elements 9 along the outer circumference of the cam disk 12, i.e. diametrically opposed. Each cam 13 forms an essentially rounded protrusion relative to the flat, curved friction surface 10.

The friction elements 9 are supported on the mounting 4 to be fixed in the tangential direction of the friction surface 10 and are spring-loaded against the friction surface 10 to be radially movable in the radial direction of the friction surface 10. A respective plate spring 14 is provided for each friction element 9 to spring load the friction elements 9 in the exemplary embodiment of the apparatus 1 shown. Other spring elements can also be used, for example flat springs or helical springs, or even more spring elements per friction element 9.

Furthermore, it can be seen from FIG. 3 that with the exemplary embodiment of the apparatus 1 shown, the side of each friction element 9 facing the friction surface 10 comprises a concave contour 15 relative to the friction surface 10. Moreover, with the apparatus 1 shown in FIG. 3, the front side and rear side of each friction element 9 defined in relation to the direction of motion of the friction element 9 relative to the friction surface 10 (the tangential direction to the friction surface 10) are each provided with a chamfer 16 on the side of the friction element 9 facing the friction surface 10.

The position of the friction elements 9 and the friction surface 10 shown in FIG. 3 corresponds to the non-operative state of the operating element 2. In said state, the friction elements 9 lie against the circular arc-shaped and flat friction surface 10, as shown in FIG. 3. With the exemplary embodiment of the apparatus 1, the entire possible operating travel of the operating element 2 corresponds to a rotation of the axle bolt 11 by about 35°.

If the operating element 2 is operated towards the operating position thereof, in the representation of FIG. 3 the cam disk 12 turns clockwise by about 35°. During this each friction element 9 initially rubs along the circular arc-shaped flat friction surface 10 with a constant contact force (=constant frictional force) until each friction element 9 has reached a cam 13. To pass onto the cam 13 during further rotation of the cam disk 12, each friction element 9 is moved outwards in the radial direction relative to the friction surface 10, whereby the bias force provided by each plate spring 14 on each friction element 9 increases until the maximum of the cam 13 is reached. This increases the effective frictional force between the friction surface 10 and the respective friction element 9.

The chamfer 16 or inclination of each friction element 9 on the front side thereof that is provided with the apparatus 1 enables adaptation to the gradient of the rising edge of each cam 13 of the friction surface 10, and thereby better control of the frictional force produced on each friction element 9. In a similar manner, the concave contour 15 on the side of each friction element 9 facing the friction surface 10 that is adapted to the shape of each cam 13 enables a more controllable force profile of the friction between the friction element 9 and the friction surface 10 when the friction element 9 is moving on the cam 13.

Once the maximum of each cam 13 is passed during further rotation of the cam disk 12 until reaching the maximum operating position of each friction element 9, the frictional force acting on each friction element 9 between the friction element 9 and the friction surface 10 reduces because the bias force of each friction element 9 produced by each plate spring 14 decreases due to the radial movement thereof inwards towards the friction surface 10. Here too, the chamfer 16 of each friction element 9 on the rear side thereof enables adaptation to the gradient of the falling edge of each cam 13 of the friction surface 10, and thereby better control of the frictional force produced on each friction element 9.

When releasing the operating element 2, the cam disk 12 shown in FIG. 3 rotates counter-clockwise due to the restoring force of the restoring spring 6 acting on the operating element 2 (FIGS. 1 and 2) until the non-operating position or initial position of the operating element 2 is reached again. The friction between the friction elements 9 and the friction surface 10 produced during the reverse travel of the cam disk 12 results in a smaller perceptible total force on the operating element 2 than on the way out, producing a desired hysteresis effect of the force-travel profile produced on the operating element 2.

The force-travel characteristic of the apparatus 1 produced on the operating element 2 in the manner described herein corresponds to a very good approximation to the force profile that is perceptible on the operating element 2 by a user operating the operating element 2 if the operating element 2 were used for operating a hydraulically operated clutch.

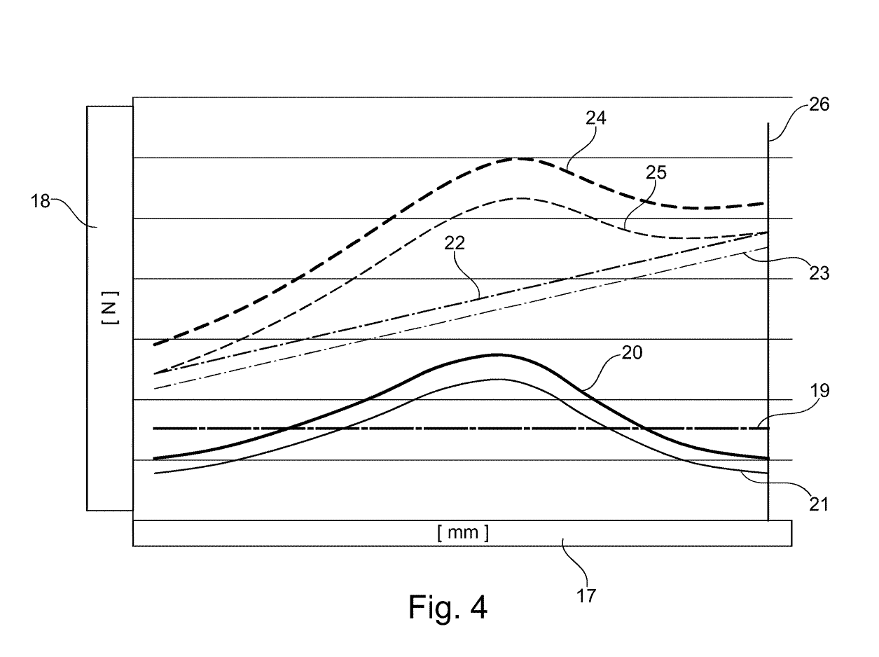

The force-travel graphs of the apparatus 1 of FIG. 1 corresponding to the preceding description are plotted in FIG. 4. In this case, the abscissa corresponds to the pedal travel 17 of the operating element 2 in millimeters and the ordinate corresponds to the force in Newtons.

The graph 19 shown in FIG. 4 corresponds to the frictional force profile of the friction element 9 rubbing on the flat circular arc-shaped friction surface 10. This is equal and constant for the forward travel and the reverse travel of the operation of the operating element 2.

The graph 20 describes the frictional force profile of the friction element 9 during the rubbing movement along a cam 13 for the forward travel of the operation of the operating element 2 (movement of the operating element 2 from the non-operating position into the operating position). As previously described, the force profile initially rises with the movement of the friction element 9 along the rising edge of the cam 13, reaches a maximum force and falls again to the initial value thereof during the movement along the falling edge of the cam 13.

The graph 21 describes the frictional force profile of the friction element 9 during the rubbing movement along a cam 13 for the return travel of the operation of the operating element 2 (movement of the operating element 2 from the operating position into the non-operating position). Qualitatively, the graph 21 corresponds to the profile of the graph 20, but the frictional force of the graph 21 is reduced compared to the graph 20 because of the friction produced between the friction elements 9 and the friction surface 10 (hysteresis).

The graph 22 shown in FIG. 4 represents the linear force profile of the spring force produced by the restoring spring 6 for the forward travel of the operation of the operating element 2. The graph 23 represents the linear force profile of the spring force produced by the restoring spring 6 for the return travel of the operation of the operating element 2. Here too a hysteresis characteristic of said force profile results because of internal friction of the restoring spring 6 (for example a helical coil spring).

The graph 24 represents the total force profile that results from the addition of the individual force profiles of the graphs 19, 20 and 22 for the forward travel of the operation of the operating element 2. The graph 25 represents the total force profile that results from the addition of the individual force profiles of the graphs 19, 21 and 23 for the return travel of the operation of the operating element 2 (hysteresis).

The maximum possible pedal travel 17 (for example on reaching an end stop) is illustrated by the graph 26.

As can be seen from FIGS. 1 and 2, a respective friction surface 10 and four friction elements 9 are disposed on both axial ends of the axle bolt 11, i.e. on both sides of the operating element 2, as previously described. In total, the exemplary embodiment of the apparatus 1 therefore comprises two frictional surfaces 10 and a total of eight friction elements 9. This enables the contact force per friction element 9 on the friction surface 10, and thereby the wear or the abrasion of the friction elements 9, to be considerably reduced, so that the apparatus 1 has a longer service life and greater durability.

The friction elements 9 are preferably made of a POM material (polyoxymethylene), with which approximately at least 1.2 million operating cycles of the apparatus 1 can be achieved with the embodiment of the apparatus 1 shown in the figures.

The apparatus for force simulation described above as well as the electrically operated clutch system according to the invention are not limited to the embodiment disclosed herein, but also have identically acting further embodiments.

For example, a reversal of the movement of the friction surface and the friction element is conceivable, with which instead of the friction surface the at least one friction element rotates about the pivot axis of the operating element, wherein in that case the friction surface is at rest relative to the mounting. In this case the at least one friction element would for example be rotationally fixedly joined to the axle bolt, so that the operation of the operating element would cause the rotation of the at least one friction element.

Moreover, the apparatus is not limited to the use of a clutch operating element for the electronic control of a clutch system of a vehicle, but can of course generally be used for control of a vehicle operation, for example including an electronic brake controller, an electronic acceleration controller or any other electronic controller that uses an operating element on which the haptic feedback of a conventional mechanical coupling of the operating element with the final control element thereof is to be simulated by means of a predetermined force-travel characteristic.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for force simulation that imparts haptic feedback by means of a predetermined force-travel characteristic, comprising:
an operating element;
a mounting;
an axle bolt supported on the mounting for rotation about a pivot axis, and fixedly joined to the operating element such that the operating element pivots between a non-operating position and an operating position;
a restoring spring configured to exert a restoring force on the operating element towards the non-operating position thereof;
at least one cam joined to the axle bolt and having a curved friction surface; and
at least one friction element spring-loaded against the friction surface and radially movable in relation to the friction surface, wherein each friction element moves along the friction surface of one of the at least one cams in response to movement of the operating element from the non-operating position to the operating position.

2. The apparatus of claim 1 wherein respective cams and friction elements are disposed on each axial end of the axle bolt.

3. The apparatus of claim 1 wherein the friction surface is formed by an external peripheral surface of the cam forming at least one sector of a circle.

4. The apparatus of claim 1 wherein the at least one friction element comprises two friction elements and the friction surface forms a complete peripheral cylindrical shell surface on which at least two diametrically disposed cam lobes are disposed, wherein the friction elements are also diametrically disposed and a respective friction element is associated with a cam lobe such that during operation of the operating element, the friction surface and each friction element move relative to each other in such a way that a respective friction element moves along the friction surface over the cam lobe that is associated therewith.

5. The apparatus of claim 1 wherein a side of the friction element facing the friction surface includes a concave contour relative to the friction surface.

6. The apparatus of claim 1 wherein the friction element has a first chamfer between a front side and a side facing the friction surface.

7. The apparatus of claim 6 wherein the friction element has a second chamfer between a back side and the side facing the friction surface.

8. The apparatus of claim 1 wherein each friction element is provided with a plate spring that biases the friction element in relation to the friction surface radially against said friction surface.

9. The apparatus of claim 1 wherein the restoring spring is a linearly operated spring element.

10. A clutch pedal comprising:
a lever fixed to an axle and supported for rotation about an axis relative to a mounting;
a cam fixed to the axle; and
a friction element spring-mounted to the mounting such that a friction surface of the cam forces the friction element to move radially relative to the axis in response to rotation of the lever to simulate hydraulic actuation of a clutch.

11. The clutch pedal of claim 10 wherein a surface of the friction element facing the cam has a concave profile.

12. The clutch pedal of claim 11 wherein the friction element has a chamfer adjacent to the surface with the concave profile.

13. The clutch pedal of claim 11 wherein the friction element has two chamfers on opposite sides of the surface with the concave profile.

14. The clutch pedal of claim 10 further comprising a restoring spring configured to bias the lever toward a first position.

15. A clutch pedal comprising:
a lever fixed to an axle and supported for rotation about an axis relative to a mounting;
two cams fixed to opposite ends of the axle; and
a plurality of friction elements spring-mounted to the mounting such that friction surfaces of the cams force the friction elements to move radially relative to the axis in response to rotation of the lever to simulate hydraulic actuation of a clutch.

16. The clutch pedal of claim 15 wherein each friction element has a surface with a concave profile facing a respective cam of the two cams.

17. The clutch pedal of claim 16 wherein each friction element has a chamfer adjacent to the surface with the concave profile.

18. The clutch pedal of claim 16 wherein each friction element has two chamfers on opposite sides of the surface with the concave profile.

19. The clutch pedal of claim 15 further comprising a restoring spring configured to bias the lever toward a first position.
